(19) United States
(12) Patent Application Publication
(10) Pub. No.: US 2023/0064366 A1
(43) Pub. Date: Mar. 2, 2023

(54) ELECTRONIC APPARATUS THAT ANNOUNCES NECESSITY TO PREPARE FOR RESTORATION OF DRIVE ROLLER, BEFORE RESTRICTING ROTATION THEREOF, AND IMAGE FORMING APPARATUS

(71) Applicant: KYOCERA Document Solutions Inc., Osaka (JP)

(72) Inventors: Haruki SAYAMA, Osaka (JP); Daijiro UENO, Osaka (JP); Tetsuya UENO, Osaka (JP); Hisaji KAWAI, Osaka (JP); Hitoshi HAYAMIZU, Osaka (JP)

(73) Assignee: KYOCERA Document Solutions Inc., Osaka (JP)

(21) Appl. No.: 17/894,499

(22) Filed: Aug. 24, 2022

(30) Foreign Application Priority Data
Aug. 31, 2021 (JP) 2021-141228

(51) Int. Cl. B41J 2/20; G08B 21/18

(52) U.S. Cl. CPC B41J 2/20; G08B 21/187

(57) ABSTRACT

An electronic apparatus includes a drive roller, a contamination detection device that detects a degree of uncontaminatedness of a surface of the drive roller, a drive motor, a controller, and a display device. The controller executes a first feedback control, when the degree of uncontaminatedness is equal to or higher than a first threshold, executes a second feedback control including increasing the driving force to the drive motor, and displays a first screen announcing necessity to prepare for restoration of the drive roller on the display device, when the degree of uncontaminatedness is lower than the first threshold, and equal to or higher than a second threshold lower than the first threshold, and restricts the drive roller from rotating, and displays a second screen requesting restoration of the drive roller on the display device, when the degree of uncontaminatedness is lower than the second threshold.

### INCORPORATION BY REFERENCE

This application claims priority to Japanese Patent Application No. 2021-141228 filed on Aug. 31, 2021, the entire contents of which are incorporated by reference herein.

### BACKGROUND

The present disclosure relates to an electronic apparatus and an image forming apparatus, and in particular to a technique to announce necessity to prepare for restoration of a drive.

Some techniques to detect contamination of a rotary member are known. Examples of such techniques include performing deterioration diagnosis and contamination diagnosis of lubricating oil, using chromaticity information of the lubricating oil of the rotary member, acquired with an optical sensor.

### SUMMARY

The disclosure proposes further improvement of the foregoing techniques.

In an aspect, the disclosure provides an electronic apparatus including a drive roller, a bearing, a contamination detection device, a drive motor, a control device, and a display device. The drive roller rotates about an axial line. The bearing rotatably supports the drive roller. The contamination detection device detects a degree of uncontaminatedness of a surface of the drive roller in a proximity of the bearing. The drive motor is connected to the drive roller. The control device includes a processor, and acts as a controller when the processor executes a control program. The controller causes the drive motor to rotate the drive roller. The controller executes a first feedback control including causing the drive roller to rotate at a predetermined speed, by adjusting a driving force applied to the drive motor according to rotation speed of the drive roller, when the degree of uncontaminatedness detected by the contamination detection device is equal to or higher than a predetermined first threshold. The controller executes a second feedback control including maintaining the rotation speed of the drive roller at the predetermined speed, by increasing the driving force applied to the drive motor from the first feedback control, and causes the display device to display a first screen for announcing necessity to prepare for restoration of the drive roller, when the degree of uncontaminatedness is lower than the first threshold, and equal to or higher than a predetermined second threshold set to a lower level than the first threshold. The controller restricts the drive roller from rotating, and causes the display device to display a second screen for requesting restoration of the drive roller, when the degree of uncontaminatedness is lower than the second threshold.

### BRIEF DESCRIPTION OF THE DRAWINGS

FIG. 1 is a front cross-sectional view showing a structure of an image forming apparatus;

FIG. 2 is a schematic cross-sectional view showing a configuration of a portion around an end portion of a drive roller;

FIG. 3 is a block diagram showing an internal configuration of the image forming apparatus;

FIG. 4 is a flowchart showing a contamination detecting operation;

FIG. 5 is a graph showing an example of a light volume distribution acquired;

FIG. 6 is a graph showing another example of the light volume distribution acquired;

FIG. 7 is a schematic drawing showing an example of a first screen;

FIG. 8 is a graph showing still another example of the light volume distribution acquired; and

FIG. 9 is a schematic drawing showing an example of a second screen.

### DETAILED DESCRIPTION

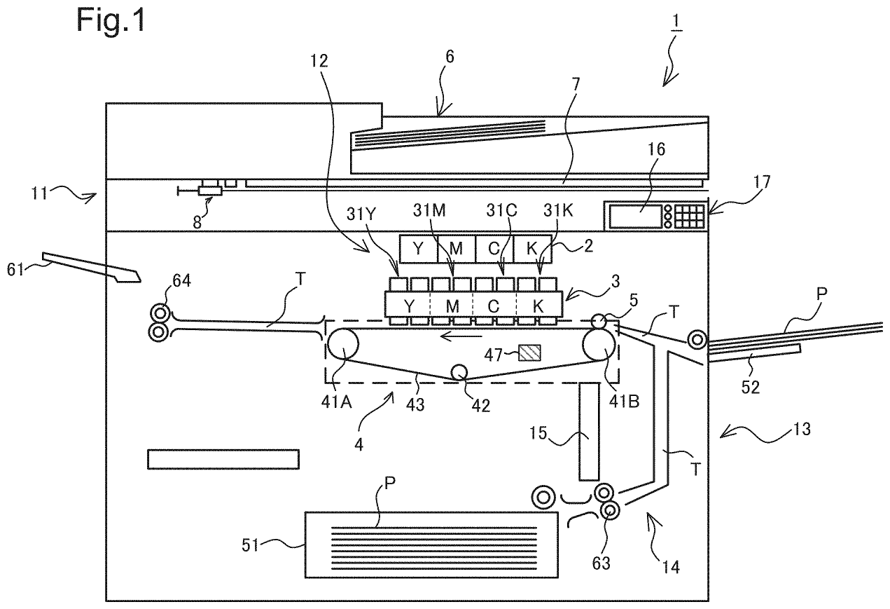

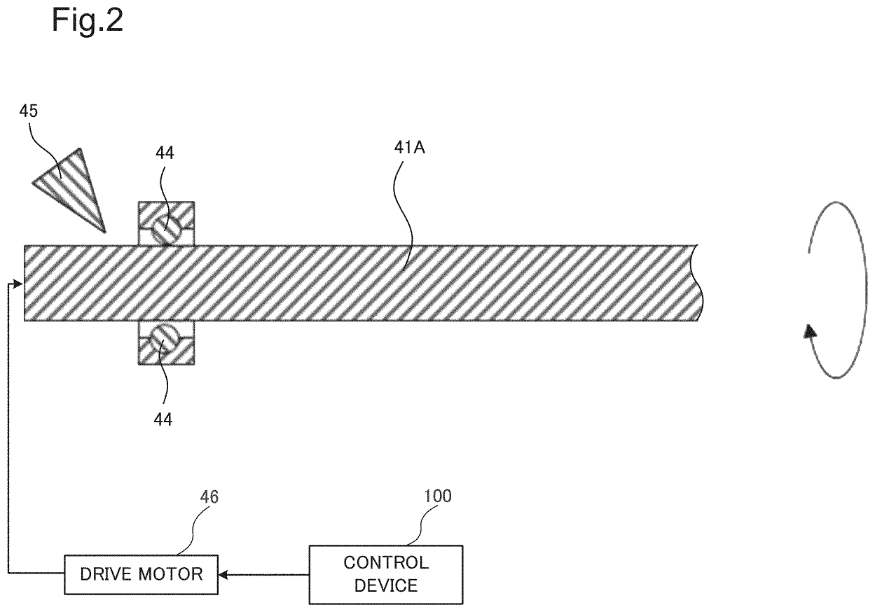

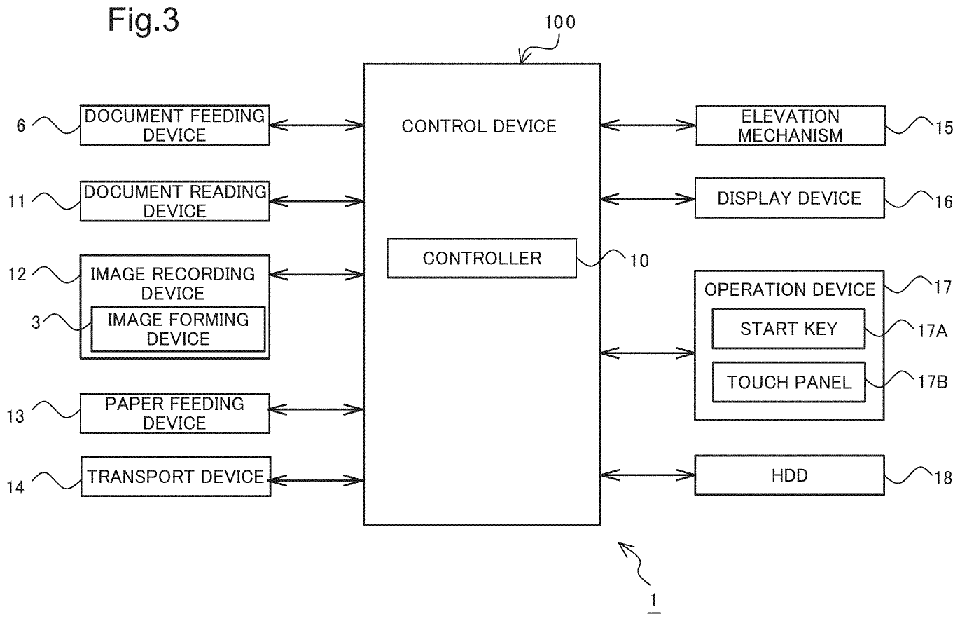

Hereafter, an image forming apparatus including an electronic apparatus according to an embodiment of the disclosure will be described, with reference to the drawings. FIG. 1 is a front cross-sectional view showing a structure of the image forming apparatus including the electronic apparatus according to the embodiment of the disclosure. FIG. 2 is a schematic cross-sectional view showing a configuration of a portion around an end portion of a drive roller. FIG. 3 is a block diagram showing an internal configuration of the image forming apparatus.

Referring to FIG. 1, the image forming apparatus 1 is an ink jet recording apparatus. In the casing of the image forming apparatus 1, a plurality of components for realizing various functions of the image forming apparatus 1 are provided. For example, a document reading device 11, an image recording device 12, a paper feeding device 13, a transport device 14, and an elevation mechanism 15 are provided inside the casing. On the upper face of the casing, a display device 16 and an operation device 17 are provided.

The document reading device 11 is configured as an automatic document feeder (ADF) including a document feeding device 6 that delivers a source document placed on a document table, and a scanner 8 that optically reads the source document, delivered from the document feeding device 6 or placed on a platen glass 7. The document reading device 11 reads the image of the source document, by emitting light from a light emitting device of the scanner 8 to the source document and receiving the reflected light with a charge-coupled device (CCD) sensor, and generates image data representing the document image.

The image recording device 12 includes an ink tank 2, an image forming device 3, a conveyor unit 4, and an adsorption roller 5. The ink tank 2 is loaded with inks respectively corresponding to yellow, magenta, cyan, and black colors. The image forming device 3 forms an image on a recording sheet P transported by the conveyor unit 4.

To be more detailed, the image forming device 3 includes line heads 31Y, 31M, 31C, and 31K, respectively corresponding to the yellow, magenta, cyan, and black colors. The image forming device 3 ejects the ink from each of the line heads 31Y, 31M, 31C, and 31K onto the recording sheet P being transported by the transport device 14, according to the image data generated by the document reading device 11, thereby recording the color image representing the document image.

As shown in FIG. 1 and FIG. 2, the conveyor unit 4 includes a drive roller 41A, a follower roller 41B, a tension roller 42, a transport belt 43, a bearing 44, a first optical sensor 45, a drive motor 46, and a second optical sensor 47. The drive roller 41A is configured to rotate about the axial line thereof. Although the material of the drive roller 41A is not specifically limited, the surface of the drive roller 41A is predominantly formed of iron, in this embodiment. In addition, the surface of the drive roller 41A has silver gloss, in a normal state.

The drive roller 41A is connected to the drive motor 46, to rotate counterclockwise when driven by the drive motor 46. The transport belt 43 is an endless belt engaged around the drive roller 41A, the follower roller 41B, and the tension roller 42. The transport belt 43 is driven by the drive roller 41A, so as to rotate counterclockwise. The follower roller 41B and the tension roller 42 follow up the rotation of the transport belt 43, to rotate counterclockwise.

The bearing 44 rotatably supports the drive roller 41A. A plurality of the bearings 44 are provided at each of the end portions of the drive roller 41A in the axial direction. Although any of the bearings for general use may be employed, a ball bearing is adopted as the bearing 44 in this embodiment.

The first optical sensor 45 is a reflective optical sensor, located in the proximity of a contact portion between an end portion of the drive roller 41A and the bearing 44. The first optical sensor 45 emits light to the surface of the drive roller 41A in the proximity of the contact portion, from a light emitting element such as a light emitting diode (LED), and receives the light reflected by the surface of the drive roller 41A with a photodetector, thereby detecting the light volume of the reflected light.

A scale is provided on the transport belt 43, at a predetermined position. The second optical sensor 47 is located in the proximity of the transport belt 43, to detect the scale on the transport belt 43. The second optical sensor 47 is also a reflective optical sensor, similar to the first optical sensor 45.

The adsorption roller 5 is located in contact with the transport belt 43, and opposed to the follower roller 41B. The adsorption roller 5 electrically charges the transport belt 43, thereby causing the recording sheet P delivered from the paper feeding device 13 to electrostatically adsorb to the transport belt 43.

The paper feeding device 13 includes a paper cassette 51 and a manual bypass tray 52. The paper feeding device 13 draws out the recording sheet P stored in the paper cassette 51 or manual bypass tray 52 one by one, with a pickup roller caused to rotate by a paper feeding motor, to deliver the recording sheet P to a transport route T.

The transport device 14 transports the recording sheet P, and delivers the recording sheet P to an output tray 61. To be more detailed, the transport device 14 includes the transport route T, along which the recording sheet P is transported from the paper feeding device 13 to the output tray 61, a transport roller pair 63 and a delivery roller pair 64 each located at a predetermined position on the transport route T, and transport motors respectively connected to the transport roller pair 63 and the delivery roller pair 64. The transport device 14 transports the recording sheet P along the transport route T, using the transport roller pair 63 and the delivery roller pair 64 caused to rotate by the transport motor, and delivers the recording sheet P to the output tray 61.

The elevation mechanism 15 sustains the conveyor unit 4 from below. The elevation mechanism 15 moves the conveyor unit 4 up and downward, with respect to the line heads 31Y, 31M, 31C, and 31K. In other words, the elevation mechanism 15 moves the conveyor unit 4 relative to the line heads 31Y, 31M, 31C, and 31K, thereby moving the conveyor unit 4 close to or away from the line heads 31Y, 31M, 31C, and 31K. To be more detailed, the elevation mechanism 15 moves the conveyor unit 4 between a recording position that enables the image forming device 3 to execute the printing operation (position shown in FIG. 1), and a position spaced from the recording position by a predetermined distance.

The display device 16 is, for example, constituted of an LCD or an organic light-emitting diode (OLED) display. The display device 16 displays various types of screen related to the functions that the image forming apparatus 1 is configured to perform.

Referring to FIG. 3, the image forming apparatus 1 includes a control device 100. The control device 100 includes a processor, a random-access memory (RAM), a read-only memory (ROM), and so forth. The processor is, for example, a central processing unit (CPU), a micro processing unit (MPU), or an application specific integrated circuit (ASIC).

The control device 100 is electrically connected to the document feeding device 6, the document reading device 11, the image recording device 12, the paper feeding device 13, the transport device 14, the elevation mechanism 15, the display device 16, the operation device 17, and the HDD 18. Here, the conveyor unit 4, the display device 16, and the control device 100 of the image recording device 12 act as the electronic apparatus according to this embodiment.

The operation device 17 includes a plurality of hard keys, such as a start key 17A, for instructing the execution of various functions of the image forming apparatus 1. The operation device 17 also includes touch panel 17B overlaid on the display device 16. The user can input various types of information, such as the instruction to execute the function of the image forming apparatus 1, through the operation device 17.

The HDD 18 is a large-capacity storage device for storing various types of data, such as the image data generated by the document reading device 11. In the HDD 18, various control programs for realizing the functions that the image forming apparatus 1 is configured to perform, are stored. As an example of such control programs, a detection program for executing a contamination detecting operation, according to the embodiment of the disclosure, is stored in the HDD 18.

The control device 100 acts as a controller 10, when the processor executes a control program stored in the ROM or the HDD 18. Here, the controller 10 may be constituted of a logic circuit, instead of being realized by the operation according to the control program. The controller 10 controls the operation of the components of the image forming apparatus 1.

By operating according to the detection program, for example, the controller 10 executes the contamination detecting operation, including rotating the drive roller 41A, when the degree of uncontaminatedness of the surface of the drive roller 41A is equal to or higher than a predetermined first threshold, rotating the drive roller 41A and causing the display device 16 to display a first screen for announcing necessity to prepare for restoration of the drive roller 41A, when the degree of uncontaminatedness is lower than the first threshold and equal to or higher than a second threshold set to a lower level than the first threshold, and restricting the drive roller 41A from rotating and causing the display device 16 to display a second screen for requesting the restoration of the drive roller, when the degree of uncontaminatedness is lower than the second threshold.

A power source is provided for each of the components of the image forming apparatus 1, so that those components are activated with the power supplied from the power source.

### [Operation]

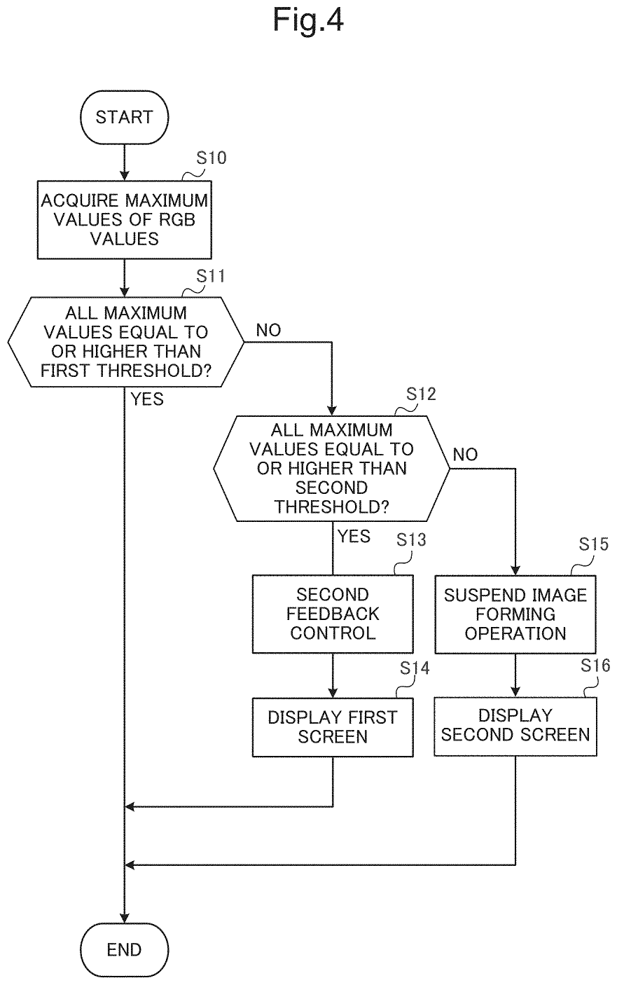

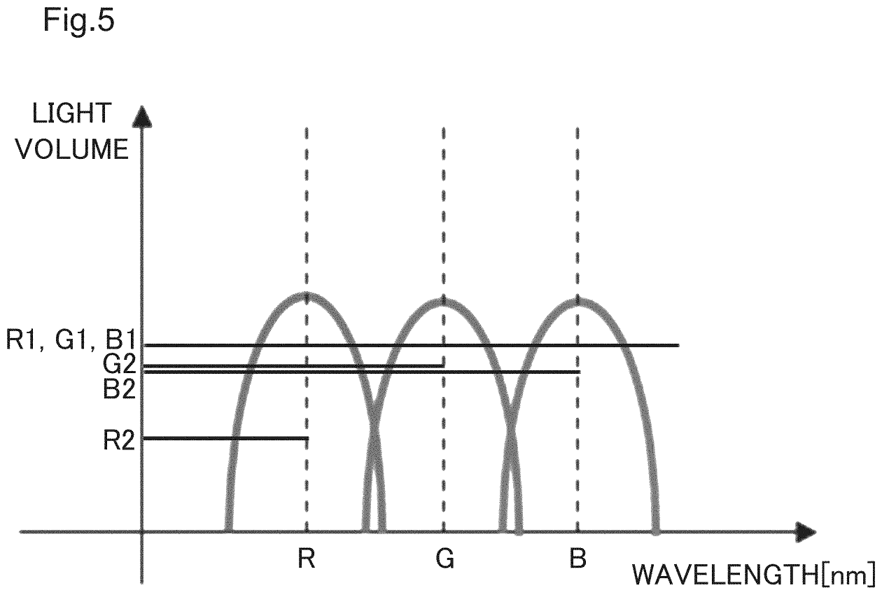

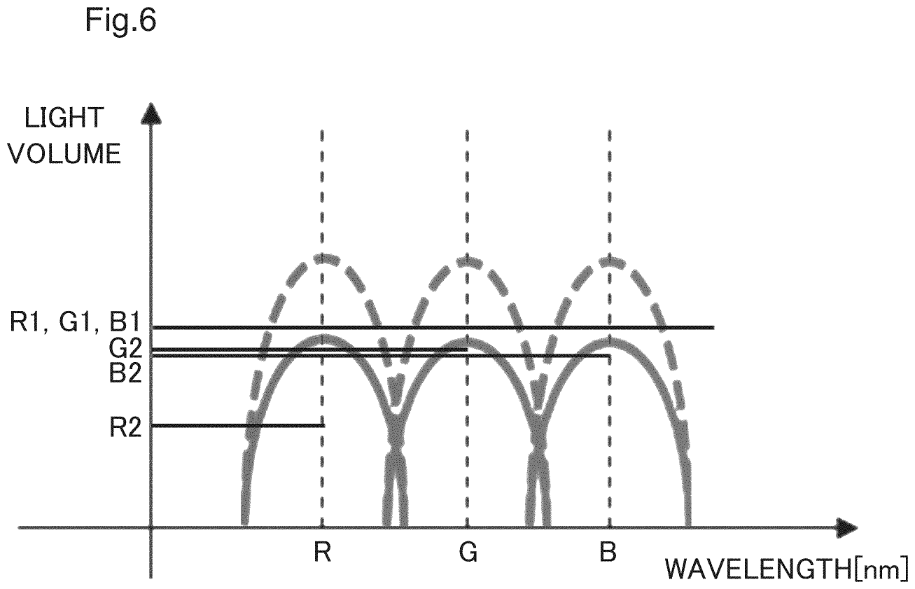

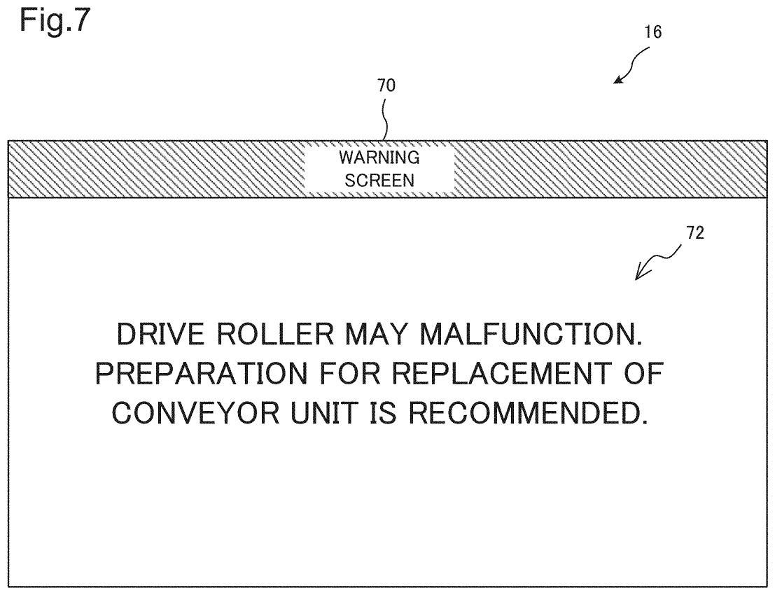

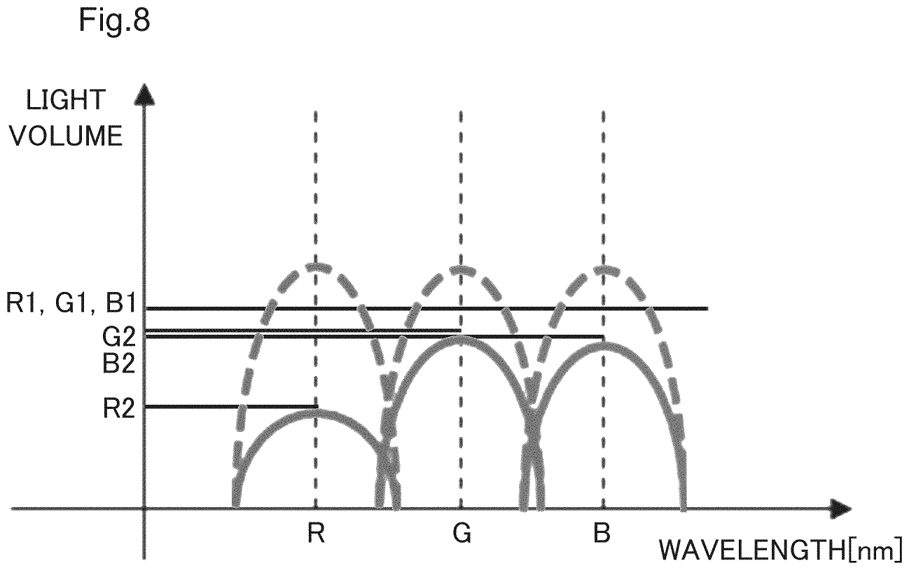

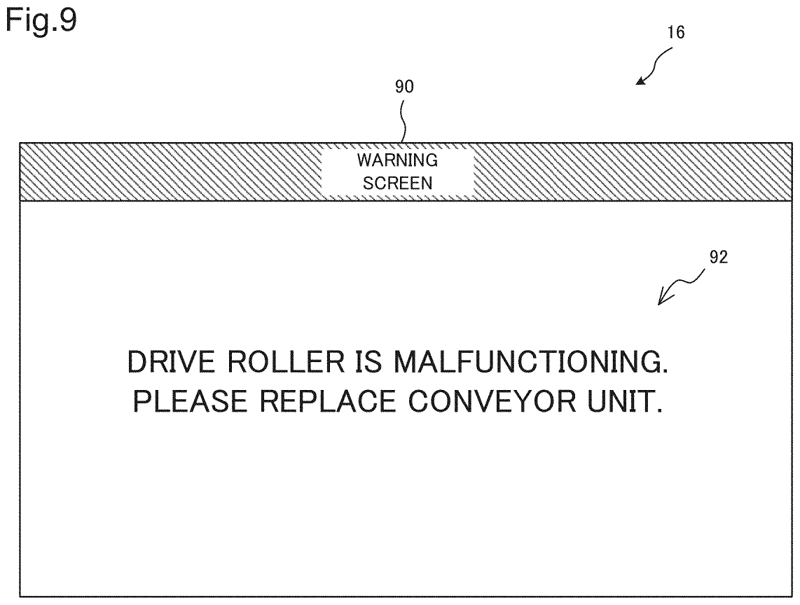

FIG. 4 is a flowchart showing the contamination detecting operation. FIG. 5, FIG. 6, and FIG. 8 each illustrate an example of the light volume distribution acquired. FIG. 7 illustrates an example of the first screen. FIG. 9 illustrates an example of the second screen. Referring to FIG. 4 to FIG. 9, the operation performed by the image forming apparatus 1 to execute the contamination detecting operation will be described hereunder. For the following description, it will be assumed that the power to the image forming apparatus 1 is turned on.

It is assumed here that the user has placed the source document on the platen glass 7 of the document reading device 11, and pressed the start key 17A to instruct the start of the copying operation. Upon detecting that the start key 17A has been pressed, the controller 10 causes the document reading device 11 to read the source document and generate the image data. The controller 10 also causes the image recording device 12 to execute the image forming operation, including forming the document image represented by the generated image data, on the recording sheet P.

When the image forming operation is started, the controller 10 executes a first feedback control, including adjusting the driving force applied to the drive motor 46 depending on the rotation speed of the drive roller 41A, thereby causing the drive roller 41A to rotate at a predetermined speed. To be more detailed, the controller 10 acquires a detection interval of the scale as the rotation speed of the drive roller 41A, on the basis of the detection result provided by the second optical sensor 47, and feeds back the comparison result between the acquired detection interval and a predetermined reference value to the control of the drive motor 46, thereby maintaining the rotation speed of the drive roller 41A at the predetermined speed, thus to maintain the rotation speed of the transport belt 43. Here, the second optical sensor 47 and the controller 10 act as the speed detection device in the disclosure.

More specifically, in the first feedback control, the controller 10 increases the driving force currently applied to the drive roller 41A, when the detection interval of the scale is longer than a predetermined reference value, so as to reach a predetermined first driving force specified according to a difference between the scale detection interval and the reference value, thereby increasing the rotation speed of the transport belt 43. When the scale detection interval is shorter than the reference value, the controller 10 reduces the driving force currently applied to the drive roller 41A, to a predetermined second driving force specified according to the mentioned difference, thereby reducing the rotation speed of the transport belt 43.

When the image forming operation is started, the controller 10 starts to execute the contamination detecting operation shown in FIG. 4, and acquires maximum values of RGB values, on the basis of the distribution of the light volume detected by the first optical sensor 45 (step S10). The acquired maximum values of the RGB values indicate the degree of uncontaminatedness of the surface of the drive roller 41A in the proximity of the bearing 44. In this embodiment, it will be assumed that the degree of contamination of the surface of the drive roller 41A becomes higher, the smaller the maximum values of the RGB values are, for example with respect to the respective maximum values of the RGB values of the drive roller at the time of shipment from the plant, completely free from contamination (hereinafter, “uncontaminated state”), as the reference. Here, the first optical sensor 45 and the controller 10 act as the contamination detection device in the disclosure.

After step S10, the controller 10 decides whether all of the acquired maximum values of the RGB values are equal to or higher than first thresholds R1, G1, and B1, respectively prespecified with respect to the RGB values (i.e., R-value, G-value, and B-value) (step S11). The first thresholds R1, G1, and B1 may be specified in advance, through experiments. In this embodiment, the controller 10 specifies the same value for each of the first thresholds R1, G1, and B1.

(1) When all Maximum Values are Equal to or Higher than First Threshold

In the case where the surface of the drive roller 41A is in the uncontaminated state, with nothing stuck thereto, the controller 10 acquires the light volume distribution, for example shown in FIG. 5, on the basis of the detection result from the first optical sensor 45, and acquires the value of the central wavelength of each of the RGB values, as the maximum value (step S10). In this case, the relative ratio of the light volume distribution of each of the RGB values is substantially the same, and all of the maximum values of the RGB values are higher than the first thresholds R1, G1, and B1.

The controller 10 decides that the all of the maximum values of the RGB values are equal to or higher than the first thresholds R1, G1, and B1 (YES at step S11), and finishes the contamination detecting operation, and continues with the first feedback control without restricting the image recording device 12 from executing the image forming operation.

(2) When at Least One of Maximum Values is Lower than First Threshold
(2-1) When all Maximum Values are Equal to or Higher than Second Threshold

Here, it is assumed that, because of continued friction between the surface of the drive roller 41A and the plurality of bearings 44, black swarf, generated by oxidation of the surface of the drive roller 41A due to friction heat, or black liquid which is the mixture of the swarf and lubricating oil, is stuck to the surface of the drive roller 41A.

The controller 10 acquires the light volume distribution, for example shown in FIG. 6, on the basis of the detection result from the first optical sensor 45, and acquires the value of the central wavelength of each of the RGB values, as the maximum value (step S10). In this case, the relative ratio of the light volume distribution of each of the RGB values is substantially the same, as in the case of the uncontaminated state. On the other hand, the light volumes are lower than the case of the uncontaminated state as a whole, and all of the maximum values of the RGB values are lower than the first thresholds R1, G1, and B1.

The controller 10 decides that all of the maximum values of the RGB values are not equal to or higher than the first thresholds R1, G1, and B1, in other words at least one of the maximum values of the RGB values is lower than the first threshold R1, G1, or B1 (NO at step S11), and decides whether all of the maximum values of the RGB values are equal to or higher than predetermined second thresholds R2, G2, and B2 (step S12).

The controller 10 sets the second thresholds R2, G2, and B2 to a value lower than the first thresholds R1, G1, and B1, respectively (i.e., R2<R1, G2<G1, B2<B1). The second thresholds R2, G2, and B2 may be specified in advance, through experiments. In this embodiment, the controller 10 specifies different values for each of the second thresholds R2, G2, and B2.

In this case, as shown in FIG. 6, all of the maximum values of the RGB values are higher than the second thresholds R2, G2, and B. The controller 10 decides that all of the maximum values of the RGB values are equal to or higher than the second thresholds R2, G2, and B (YES at step S12), and executes a second feedback control, instead of the first feedback control, including increasing the driving force applied to the drive motor 46 from the first feedback control, thereby maintaining the rotation speed of the drive roller 41A at the predetermined speed (step S13).

To be more detailed, in the second feedback control, the controller 10 increases the driving force currently applied to the drive roller 41A, when the scale detection interval is longer than the reference value, by an increment specified in advance according to the difference between the scale detection interval and the reference value, so as to exceed the first driving force. When the scale detection interval is shorter than the reference value, the controller 10 reduces the driving force currently applied to the drive roller 41A, by an amount specified in advance according to the mentioned difference, to a level lower than the second driving force.

After step S13, the controller 10 causes the display device 16 to display a first screen 70 including a message 72 for announcing the necessity to prepare for restoration of the conveyor unit 4, as shown in FIG. 7 (step S14). After step S14, the controller 10 finishes the contamination detecting operation.

(2-2) When at Least One of Maximum Values is Lower than Second Threshold

It is assumed here that a colored foreign matter is stuck to the surface of the drive roller 41A. In this case, the controller 10 acquires the light volume distribution, for example shown in FIG. 8, on the basis of the detection result from the first optical sensor 45, and acquires the value of the central wavelength of each of the RGB values, as the maximum value (step S10).

In this case, the relative ratio of the light volume of each of the RGB values is different from each other, unlike in the case of the uncontaminated state. In addition, the light volumes are lower than the case of the uncontaminated state as a whole, and all of the maximum values of the RGB values are lower than the first thresholds R1, G1, and B1. Accordingly, the controller 10 decides that all of the maximum values of the RGB values are not equal to or higher than the first thresholds R1, G1, and B1, in other words at least one of the maximum values of the RGB values is lower than the first threshold R1, G1, or B1 (NO at step S11), and proceeds to step S12.

As shown in FIG. 8, all of the maximum values of the RGB values are lower than the second thresholds R2, G2, and B2. Accordingly, the controller 10 decides that all of the maximum values of the RGB values are not equal to or higher than the second thresholds R2, G2, and B2, in other words at least one of the maximum values of the RGB values is lower than the second threshold R2, G2, or B2 (NO at step S12), and restricts the image recording device 12 from executing the image forming operation (step S15).

At step S15, the controller 10 restricts the drive roller 41A from rotating. To be more detailed, the controller 10 stops the rotation of the drive roller 41A, after allowing the drive roller 41A to rotate until the conveyor unit 4 enters a predetermined state that is appropriate for the restoration (e.g., the recording sheet P has been discharged from the conveyor unit 4).

After step S15, the controller 10 causes the display device 16 to display a second screen 90 including a message 92 for requesting the restoration of the conveyor unit 4, as shown in FIG. 9 (step S16). After step S16, the controller 10 finishes the contamination detecting operation.

Now, with the continued friction between the surface of the drive roller and the bearing, originating from the rotation of the drive roller, the iron constituting the surface of the drive roller is oxidated owing to the friction heat, and black swarf is generated. When the surface of the drive roller is contaminated, with such sward or other foreign matter stuck thereto, the rotation resistance of the drive roller is increased, which impedes the drive roller from constantly maintaining the rotation speed through a normal feedback control, and therefore irregular rotation is detected. When the irregular rotation of the drive roller is detected, generally, the rotation of the drive roller is stopped, and the request for the restoration of the drive roller is notified to the user.

However, when the mentioned action is taken, the drive roller remains restricted from rotating, until the drive roller is restored, and the downtime may be prolonged. The foregoing known technique is merely related to the deterioration diagnosis and contamination diagnosis of the lubricating oil of a rotary member, and does not provide the solution to the mentioned problem.

According to this embodiment, in contrast, the controller 10 executes the first feedback control, when all of the maximum values of the RGB values, acquired as the degree of uncontaminatedness, are equal to or higher than the first thresholds R1, G1, and B1. When at least one of the maximum values of the RGB values is lower than the first threshold R1, G1, or B1, and all of the maximum values of the RGB values are equal to or higher than the second thresholds R2, G2, and B2, the controller 10 executes the second feedback control, and causes the display device 16 to display the first screen 70. When at least one of the maximum values of the RGB values is lower than the second threshold R2, G2, or B2, the controller 10 restricts the drive roller 41A from rotating, and causes the display device 16 to display the second screen 90.

Thus, the rotation speed of the drive roller 41A can be maintained at the predetermined speed, and the necessity to prepare for the restoration of the drive roller 41A can be announced, through the second feedback control, even when the rotation speed of the drive roller 41A becomes unable to be maintained at the predetermined speed through the first feedback control, owing to the contamination of the surface of the drive roller 41A. Such an arrangement enables the user to secure the time to prepare for the restoration, before the contamination of the surface of the drive roller 41A reaches such a level that the drive roller 41A has to be restricted from rotating. Therefore, even when the irregular rotation has occurred owing to the contamination of the surface of the drive roller 41A, the downtime from the restriction of the rotation of the drive roller 41A to the restoration can be shortened, compared with the case of requesting the restoration only after restricting the rotation of the drive roller 41A.

According to the foregoing embodiment, in addition, when the scale detection interval is longer than the reference value, the controller 10 increases, as the first feedback control, the driving force currently applied to the drive roller 41A, so as to reach the predetermined first driving force specified according to the mentioned difference, and reducing, when the scale detection interval is shorter than the reference value, the driving force currently applied to the drive roller 41A, to the predetermined second driving force specified according to the difference. Further, when the scale detection interval is longer than the reference value, the controller 10 increases, as the second feedback control, the driving force currently applied to the drive roller 41A, by the amount prespecified according to the mentioned difference so as to exceed the first driving force, and reduces, when the scale detection interval is shorter than the reference value, the driving force currently applied to the drive roller 41A, by the amount prespecified according to the mentioned difference, to the level lower than the second driving force.

The mentioned arrangement enables the rotation speed of the drive roller 41A to be easily maintained at the predetermined speed through the second feedback control, even when the rotation speed of the drive roller 41A becomes unable to be maintained at the predetermined speed through the first feedback control, thereby maintaining the rotation speed of the transport belt 43 at a constant level, by suppressing the reduction in rotation speed.

According to the foregoing embodiment, when at least one of the maximum values of the RGB values is lower than the second threshold R2, G2, or B2, the controller 10 restricts the drive roller 41A from rotating, after allowing the drive roller 41A until the conveyor unit 4 enters the predetermined state appropriate for the restoration. Such an arrangement facilitates the restoration work of the drive roller 41A to be carried out smoothly, thereby further shortening the downtime from the restriction of the rotation of the drive roller 41A to the restoration.

According to the foregoing embodiment, further, the image forming apparatus 1 includes the image forming device 3 that forms an image on the recording sheet P transported by means of the rotation of the drive roller 41A. Therefore, the downtime, during which the image forming operation is restricted owing to the contamination of the drive roller 41A, can be shortened.

### Other Variations

According to the foregoing embodiment, the controller 10 displays the first screen 70 at step S14, after executing the second feedback control at step S13. However, the disclosure is not limited to such embodiment. For example, the controller 10 may proceed to step S14, without executing the operation of step S13.

According to the embodiment, the controller 10 detects the scale detection interval to acquire the rotation speed of the drive roller 41A. However, the disclosure is not limited to such embodiment. For example, the image forming apparatus 1 may include an optical sensor that detects the presence of the recording sheet P being transported by the transport belt 43, so that the controller 10 may detect the detection interval of the recording sheet P to acquire the rotation speed of the drive roller 41A, on the basis of the detection result from the optical sensor.

According to the embodiment, the controller 10 detects the RGB values (i.e., light volume) as the degree of uncontaminatedness. However, the disclosure is not limited to such embodiment. For example, the controller 10 may detect, as the degree of uncontaminatedness, a deviation from a reference relative ratio, corresponding to the relative ratio of the light volume distribution of each of the RGB values, in the uncontaminated state at the time of shipment from the plant.

According to the embodiment, further, the degree of uncontaminatedness is detected from the drive roller 41A of the conveyor unit 4. However, the disclosure is not limited to such embodiment. For example, the degree of uncontaminatedness may be detected from the drive roller constituting one of the transport roller pair 63, or the drive roller constituting one of the delivery roller pair 64. In this case, the first optical sensor 45 is located in the proximity of the contact portion between the drive roller and the bearing rotatably supporting the drive roller.

Further, although the controller 10 acquires the degree of uncontaminatedness of the surface of the drive roller 41A in the proximity of the bearing 44 in the foregoing embodiment, the disclosure is not limited to such an embodiment. For example, the controller 10 may acquire the degree of uncontaminatedness from the portion of the surface of the drive roller 41A located in contact with the bearing 44. In this case, the first optical sensor 45 emits light from the light emitting element to the surface of the drive roller 41A corresponding to the contact portion, and receives the light reflected at the surface of the drive roller 41A with the photodetector, thereby detecting the light volume of the reflected light.

Further, although the image forming device 12 is configured to form an image on the recording sheet P in the embodiment, the disclosure is not limited to such an embodiment. The image forming device 12 may form an image on a different type of recording medium, such as an overhead projector (OHP) sheet, without limitation to the recording sheet.

The disclosure may be modified in various manners, without limitation to the configuration according to the foregoing embodiment. For example, although the image forming apparatus is exemplified by a color multifunction peripheral in the embodiment, a different type of image forming apparatus, such as a monochrome multifunction peripheral, a copier, or a facsimile machine, may be employed. Likewise, the electronic apparatus is not limited to the image forming apparatus 1. The electronic apparatus may be, for example, a belt conveyor.

The configurations and processings according to the foregoing embodiments, described with reference to FIG. 1 to FIG. 9, are merely exemplary and in no way intended to limit the disclosure to those configurations and processings.

While the present disclosure has been described in detail with reference to the embodiments thereof, it would be apparent to those skilled in the art the various changes and modifications may be made therein within the scope defined by the appended claims.

What is claimed is:

1. An electronic apparatus comprising:
a drive roller that rotates about an axial line;
a bearing that rotatably supports the drive roller;
a contamination detection device that detects a degree of uncontaminatedness of a surface of the drive roller in a proximity of the bearing;
a drive motor connected to the drive roller;
a control device including a processor, and configured to act as a controller, when the processor executes a control program; and
a display device,
the controller being configured to:
cause the drive motor to rotate the drive roller;
execute a first feedback control including causing the drive roller to rotate at a predetermined speed, by adjusting a driving force applied to the drive motor according to rotation speed of the drive roller, when the degree of uncontaminatedness detected by the contamination detection device is equal to or higher than a predetermined first threshold;
execute a second feedback control including maintaining the rotation speed of the drive roller at the predetermined speed, by increasing the driving force applied to the drive motor from the first feedback control, and cause the display device to display a first screen for announcing necessity to prepare for restoration of the drive roller, when the degree of uncontaminatedness is lower than the first threshold, and equal to or higher than a predetermined second threshold set to a lower level than the first threshold; and
restrict the drive roller from rotating, and cause the display device to display a second screen for requesting restoration of the drive roller, when the degree of uncontaminatedness is lower than the second threshold.

2. The electronic apparatus according to claim 1, further comprising a speed detection device that detects rotation speed of the drive roller,
wherein the controller is configured to:
increase, as the first feedback control, the driving force currently applied to the drive roller, when the rotation speed detected by the speed detection device is slower than a predetermined reference speed, by an increment specified according to a difference between the rotation speed and the reference speed, so as to reach a predetermined first driving force, and reduce, when the rotation speed is faster than the reference speed, the driving force currently applied to the drive roller, by a predetermined amount specified according to the difference, to a predetermined second driving force; and
increase, as the second feedback control, the driving force currently applied to the drive roller, when the rotation speed is slower than the reference speed, by an increment specified according to the difference so as to exceed the first driving force, and reduce, when the rotation speed is faster than the reference speed, the driving force currently applied to the drive roller, by a predetermined amount specified according to the difference, to a level lower than the second driving force.

3. The electronic apparatus according to claim 1,
Wherein, when the degree of uncontaminatedness is lower than the second threshold, the controller allows the drive roller to rotate until the drive roller enters a predetermined state appropriate for the restoration, and then restricts the drive roller from rotating.

4. The electronic apparatus according to claim 1,
wherein the contamination detection device includes an optical sensor that emits light to the surface of the drive roller in the proximity of the bearing, and detects a light volume of reflected light, and
the controller acquires maximum values of RGB values as the degree of uncontaminatedness, on a basis of distribution of the light volume detected by the optical sensor.

5. An image forming apparatus comprising:
the electronic apparatus according to claim 1; and
an image forming device that forms an image on a recording medium transported by the rotation of the drive roller.
